(19) United States
(12) Patent Application Publication
(10) Pub. No.: US 2016/0289120 A1
(43) Pub. Date: Oct. 6, 2016

(54) FLUIDITY-RETAINING AGENT FOR HYDRAULIC COMPOSITIONS, COMPATIBLE WITH A WATER-REDUCING AGENT OF THE COMB POLYMER TYPE

(71) Applicant: COATEX, Genay (FR)

(72) Inventors: David PLATEL, Saint Maurice De Gourdans (FR); Yves MATTER, Quincieux (FR); Jean-Marc SUAU, Lucenay (FR)

(73) Assignee: COATEX, Genay (FR)

(21) Appl. No.: 15/035,868

(22) PCT Filed: Nov. 12, 2014
(86) PCT No.: PCT/FR2014/052871

§ 371 Date: May 11, 2016

(30) Foreign Application Priority Data
Nov. 15, 2013 (FR) 1361234

(51) Int. Cl. C04B 24/26; C08F 220/68; C08L 33/10; C04B 28/02

(52) U.S. Cl. CPC C04B 24/2694; C04B 28/02; C08F 220/68; C08L 33/10; C04B 2103/0062

(57) ABSTRACT

The present invention relates to the technical field of hydraulic compositions, for example concrete and mortar compositions. More precisely, the present patent application relates to a slump retaining agent which is compatible with a water-reducing agent of hydrophilic comb polymer type.

### FIELD OF THE INVENTION

The present invention relates to the technical field of hydraulic compositions, for example concrete and mortar compositions. Such compositions are intended for all the construction markets. More specifically, the present patent application relates to additives used in such hydraulic compositions.

### BACKGROUND OF THE INVENTION

Hydraulic compositions generally comprise various chemical additives intended to improve their properties. Among these, use is generally made of a chemical agent whose function is to improve the state of dispersion of the mineral particles in the composition. This chemical agent is known, without preference, as a “dispersant agent”, “fluidizer”, “water-reducing agent”, “plasticizer” or “superplasticizer”. This chemical agent makes it possible to reduce the water content of hydraulic compositions, which makes it possible to improve the performances of hydraulic compositions including the mechanical strength.

A wide variety of dispersant agents exist for hydraulic compositions. These agents differ in their chemical composition and the properties that they induce in the compositions containing them.

Mention is made, for example, of documents WO 2006/028252 and WO 2003/144332, which describe the use of low molecular weight dispersant copolymers.

To evaluate the dispersant properties of the dispersant agent in the hydraulic composition, the slump is measured, in accordance with standard EN 12350-2. The greater the slump value, the more workable the hydraulic composition. The workability of the concrete is an important property which conditions its placing in position, for example for filling shuttering. It is evaluated just after its manufacture, and also at given times after manufacture, which makes it possible to evaluate the workability over time, also known as the slump retention, and also the workability time limit after manufacture.

Several categories of concretes exist. For each category of concrete, specific workability characteristics are expected.

Among the various categories of concretes, mention may be made of self-compacting concretes (SCC), which are characterized by high workability values (≧620 mm and never <500 mm). For such concretes, it is a matter of increasing their workability to be able to use them, and also to ensure good workability for a prolonged period.

Mention is also made of ready-mix concretes (RMC), which is another category of concrete that has workability values of the order of 50 mm to 200 mm.

One solution proposed for increasing the workability of concretes consists in overdosing the amount of dispersant agents used. This solution, which is very practical, nevertheless leads to a loss of stability and homogeneity of the formulation, which has a negative impact on the performances of the concrete (segregation).

Another solution consists in using setting retardant agents, in accordance with standard ADJUVANT NF EN 934-2. As soon as the anhydrous cement has been mixed with water, optionally containing additives, hydration begins and the properties of the paste thus obtained change over time. After a certain time, the crystals become increasingly large, the mixture changes in viscosity and stiffens. This corresponds to the start of setting. The use of setting retardant agents makes it possible to inhibit the step of hydration of the cement during its placing in contact with the other constituents of the concrete or mortar and/or the step of crystallization of the cement constituents. The use of setting retardant agents nevertheless has the major drawback of reducing the strength in the early stages of works.

The use of slump retaining agents is also proposed to ensure workability for a prolonged period.

Document WO 2007/047407, in particular, describes a method for increasing the workability, which consists in combining three additives: an agent for increasing the initial fluidity, a slump retaining agent and an agent which controls the response of the agent for increasing the initial fluidity when the first two agents are added to said composition.

Document WO 97/48656 describes the use of an agent of copolymer type which gives initial fluidity to a hydraulic composition such as a cement paste, a mortar or concrete and moreover makes it possible to maintain the fluidity of the composition. This concrete mixed agent consists of a copolymer consisting of (a) an ethylenically unsaturated monomer containing from 25 to 300 mol of C2-C3 oxyalkylene groups, (b) an ethylenically unsaturated monomer of alkyl, alkenyl or hydroxyalkyl ester type and optionally (c) an ethylenically unsaturated carboxylic acid or a salt thereof, said copolymer comprising a high proportion of monomers (b). Such a copolymer is presented as allowing an excellent balance between initial fluidity and slump retention, these properties being adjusted as a function of the molecular weight of the copolymer. Document EP 2 147 901 describes an agent for a dispersion maintenance for hydraulic compositions, without initial fluidity, comprising structural units based on ethylenically unsaturated carboxylate. This agent does not comprise any ethylenically unsaturated carboxylic acid groups, which, according to this document, gives the copolymer initial fluidity.

Document EP 1 655 272 A1 describes cement additives that are useful as superplasticizers which increase the workability of the cement. These additives give an initial fluidity and slump retention. These additives necessarily consist of the following three monomers: (I) ethylenically unsaturated poly(alkylene glycol) ether monomers containing from 25 to 300 units of C2-C3 oxyalkylene groups, (II) ethylenically unsaturated alkyl ester monomers comprising from 1 to 4 ethylene/propylene glycol units and (III) optionally oxyalkylated monomers comprising two ethylenic unsaturations.

Document WO 2010/064 098 (Coatex) describes the use of a combination of comb polymers as agent for improving the workability of an aqueous formulation based on hydraulic binders, one bearing hydrophilic side chains and the other hydrophobic side chains.

Document EP 0 612 702 A1 describes additives of superplasticizer type consisting of methacrylic acid, poly(ethylene glycol)monoethyl ether methacrylate and poly(ethylene glycol)dimethacrylate monomers as cross-linking agent. This document does not give any indication regarding the molecular weight of the described additives.

None of the solutions presented in these documents is entirely satisfactory.

### BRIEF DESCRIPTION OF THE INVENTION

One object of the present invention is to propose a copolymeric agent for hydraulic compositions having slump retention as an essential property.

Another object of the present invention is to propose a copolymeric agent which does not provide any initial fluidity when it is in a hydraulic composition.

Another object of the present invention is to propose a slump retaining agent that is entirely compatible with a water-reducing agent of comb polymer type bearing at least one hydrophilic side chain, i.e. to propose a slump retaining agent that is miscible in all proportions with such a water-reducing agent and which has no impact on the initial fluidity of the formulation at standard doses.

Another object of the present invention is to propose a workability agent that has an optimization of its initial fluidity and slump retention characteristics.

The slump retaining agent according to the invention, which is of particular composition, compatible with a water-reducing agent of comb polymer type bearing at least one hydrophilic side chain and the workability agent consisting of a combination of this slump retaining agent and of a particular water-reducing agent make it possible to satisfy all of these objects.

Another object of the present invention is to propose an additive which makes it possible to obtain a homogeneous composition, i.e. a composition which does not lead to a segregation of the materials in the composition.

### DETAILED DESCRIPTION OF THE INVENTION

### Slump Retaining Agent

A first object of the invention consists of a slump retaining agent for hydraulic compositions, said agent not being a water-reducing agent, consisting of a copolymer obtained by polymerization:
a) of at least one anionic monomer comprising a polymerizable unsaturated function and a carboxylic group,
b) of at least one macromonomer comprising a polymerizable unsaturated function and a polyalkoxylated chain, consisting of at least one alkoxylated unit, for example at least 10 alkoxylated units and
c) of at least one nonionic cross-linking monomer comprising at least two polymerizable unsaturated functions,
   said copolymer having a molecular weight of greater than 400 000 g/mol.

The slump retaining agent according to the invention is a concrete adjuvant incorporated at the time of mixing the concrete at a dose of less than or equal to 5% by mass/weight of the cement content of the concrete, to modify the properties of the fresh and/or hardened mix.

The agent according to the invention makes it possible to lengthen the workability time of a hydraulic composition, for example a concrete. Moreover, although it is important to lengthen the workability time of a concrete, this should not be done to the detriment either of the performances of the concrete undergoing hardening or in the hardened state (especially desired initial or final mechanical strengths), or the content of air entrained in the hydraulic compositions.

The slump retaining agent according to the invention is not a water-reducing agent or a high water-reducing agent.

In the context of the present invention, a “water-reducing agent” or a “plasticizer” is an agent which, in accordance with standard ADJUVANT NF EN 934-2, allows a water reduction for admixed concrete ≧5% relative to control concrete. A “high water-reducing agent” or “superplasticizer” is an admixture which allows a water reduction for admixed concrete ≧12% relative to control concrete.

The slump retaining agent according to the invention does not correspond to these characteristics. Thus, the slump retaining agent according to the invention is entirely compatible with a water-reducing agent, plasticizer or superplasticizer. This makes it possible to formulate hydraulic compositions suited to each construction job, without the need to adjust the amounts of one or other of the additives to obtain a desired profile of initial fluidity and of maintenance of the workability over time.

The slump retaining agent according to the invention is not, either, a setting retardant according to standard ADJUVANT NF EN 934-2. Thus, the agent according to the invention does not have any influence on the cement hydration step when it is placed in contact with the other constituents of concrete or mortar and/or the step of crystallization of the cement constituents. It has no influence on the strength in the early stages of works, for example the strength at 1 day or at 7 days.

The slump retaining agents according to the invention, with a molecular weight of greater than 400,000 g/mol, make it possible to obtain homogeneous compositions, whereas these same agents, with a molecular weight of the order of 100,000 to 150,000 g/mol, lead to a segregation of the materials in the composition. Such a significance is unacceptable since it is likely to have a negative impact on the performances of the compositions which contain them.

The embodiments described below may be combined with each other.

The retention agent according to the present invention is derived from the polymerization of monomers a), b) and c). Each monomer a), b) and c) may be present in the copolymer, alone or as a mixture of two or more entities.

Monomer a) may be in acid form, for example carboxylic acid, and/or in salt form, for example carboxylate.

The copolymer comprises, for example, one or more cross-linking monomers c). According to one embodiment, it comprises only one cross-linking monomer. According to another embodiment, it comprises two cross-linking monomers. The cross-linking monomer(s) are used to generate a copolymer in the form of a three-dimensional network.

According to the present invention, a monomer which is a polyunsaturated compound is used as cross-linking monomer c). This compound may comprise two, three or more ethylenic unsaturations.

The cross-linking monomer may have a hydrophilic, hydrophobic or amphiphilic nature. Examples of these compounds include di(meth)acrylate compounds such as polyalkylene glycol di(meth)acrylate, especially polypropylene glycol di(meth)acrylate, ethylene glycol di(meth)acrylate, polyethylene glycol di(meth)acrylate, triethylene glycol di(meth)acrylate, 1,3-butylene glycol di(meth)acrylate, 1,6-butylene glycol di(meth)acrylate, 1,6-hexanediol di(meth)acrylate, neopentyl glycol di(meth)acrylate, 1,9-nonanediol di(meth)acrylate, but also 2,2′-bis(4-(acryloxy-propyloxyphenyl)propane, 2,2′-bis(4-(acryloxydiethoxyphenyl)propane and zinc acrylate; tri(meth)acrylate compounds such as trimethylolpropane tri(meth)acrylate, trimethylolethane tri(meth)acrylate, pentaerythritol tri(meth)acrylate and tetramethylolmethane tri(meth)acrylate; tetra(meth)acrylate compounds such as ditrimethylolpropane tetra(meth)acrylate, tetramethylolmethane tetra(meth)acrylate and pentaerythritol tetra(meth)acrylate; hexa(meth)acrylate compounds such as dipentaerythritol hexa(meth)acrylate; penta(meth)acrylate compounds such as dipentaerythritol penta(meth)acrylate; allyl compounds such as allyl(meth)acrylate, diallyl phthalate, diallyl itaconate, diallyl fumarate and diallyl maleate; polyallyl sucrose ethers containing from 2 to 8 groups per molecule, polyallyl pentaerythritol ethers such as pentaerythritol diallyl ether, pentaerythritol triallyl ether and pentaerythritol tetraallyl ether; polyallyl trimethylolpropane ethers such as diallyl trimethylolpropane ether and triallyl trimethylolpropane ether. Other polyunsaturated compounds include divinyl glycol, divinylbenzene, divinylcyclohexyl and methylenebisacrylamide.

According to another aspect, the cross-linking monomers may be prepared via an esterification reaction of a polyol with an unsaturated anhydride such as maleic anhydride or itaconic anhydride or via an addition reaction with an isocyanate such as 3-isopropenyldimethylbenzene isocyanate.

Use may also be made of the following unsaturated compounds which cross-link by means of their carboxyl side groups: polyhaloalkanols such as 1,3-dichloroisopropanol and 1,3-dibromoisopropanol; haloepoxyalkanes such as epichlorohydrin, epibromohydrin, 2-methylepichlorohydrin and epiiodohydrin; polyglycidyl ethers such as 1,4-butanediol diglycidyl ether, glyceryl-1,3-diglycidyl ether, ethylene glycol diglycidyl ether, propylene glycol diglycidyl ether, diethylene glycol diglycidyl ether, neopentyl glycol diglycidyl ether, polypropylene glycol diglycidyl ether, bisphenol A-epichlorohydrin epoxy resin and mixtures thereof.

The present invention also relates to a slump retaining agent for hydraulic compositions, said agent not being a water-reducing agent (according to standard ADJUVANT NF EN 934-2), which consists of a copolymer obtained by polymerization of:
a) at least one anionic monomer comprising a polymerizable unsaturated function and a carboxylic group,
b) at least one macromonomer having a formula (I):

R_{f}-[(EO)ₘ-(PO)ₙ-(BO)ₚ]-R_{f}′ (I)
in which:
[(EO)ₘ-(PO)ₙ-(BO)ₚ] represents a polyalkoxylated chain consisting of alkoxylated units, arranged in blocks, randomly or alternatively, chosen from ethoxylated units EO, propoxylated units PO and butoxylated units BO,
m, n and p represent, independently of each other, 0 or an integer ranging from 1 to 250 (inclusive), the sum of m, n and p being between 10 and 250,
R_{f} represents a radical containing a polymerizable unsaturated function,
R_{f}′ represents hydrogen or an alkyl group containing from 1 to 4 carbon atoms and
c) at least one nonionic cross-linking monomer comprising at least two polymerizable unsaturated functions and an ester group,
   said copolymer having a molecular weight of greater than 400,000 g/mol as determined by SEC.

According to one embodiment, said slump agent is a copolymer obtained by polymerization of monomers b), in which R_{f} represents a radical containing a polymerizable unsaturated function and a carboxylic group.

According to one embodiment, said slump retaining agent is a copolymer obtained by polymerization of monomers b) and c), in which the polymerizable unsaturated functions, independently of each other, are chosen from the group consisting of acrylic esters, methacrylic esters, maleic esters, itaconic esters, crotonic esters and a mixture of these esters.

According to one embodiment, said slump retaining agent is a copolymer obtained by polymerization of monomers a) chosen from the group consisting of acrylic acid, methacrylic acid, maleic acid, itaconic acid, crotonic acid and a mixture of these monomers.

According to another embodiment, said slump agent is a copolymer obtained by copolymerization of two or more different monomers a). For example, it may be a mixture of acrylic acid monomers and of methacrylic acid monomers, or a mixture of maleic acid, acrylic acid and methacrylic acid monomers.

According to one embodiment, said slump agent is a copolymer with a molecular weight of greater than 400,000 g/mol obtained by copolymerization of:
a) at least one anionic monomer chosen from the group consisting of acrylic acid, methacrylic acid, maleic acid, itaconic acid, crotonic acid and a mixture of these monomers,
b) at least one macromonomer having a formula (I):

R_{f}-[(EO)ₘ-(PO)ₙ-(BO)ₚ]-R_{f}′ (I)
in which:
[(EO)ₘ-(PO)ₙ-(BO)ₚ] represents a polyalkoxylated chain consisting of alkoxylated units, arranged in blocks, randomly or alternatively, chosen from ethoxylated units EO, propoxylated units PO and butoxylated units BO,
m, n and p represent, independently of each other, 0 or an integer ranging from 1 to 250 (inclusive), the sum of m, n and p being between 10 and 250,
R_{f} represents a radical chosen from the group consisting of acrylic esters, methacrylic esters, maleic esters, itaconic esters, crotonic esters and a mixture of these esters,
R_{f}′ represents hydrogen or an alkyl group containing from 1 to 4 carbon atoms and
c) at least one nonionic cross-linking monomer comprising at least two radicals chosen from the group consisting of acrylic esters, methacrylic esters, maleic esters, itaconic esters, crotonic esters and a mixture of these esters.

According to yet another embodiment, said slump agent is a copolymer obtained by copolymerization of monomers a) chosen from the group consisting of acrylic acid, methacrylic acid and a mixture of these monomers.

According to another embodiment, said slump agent is a copolymer obtained by polymerization of monomers b) and c), in which the polymerizable unsaturated functions, independently of each other, are chosen from the group consisting of acrylic esters, methacrylic esters and a mixture of these esters.

According to one embodiment, the slump agent according to the invention consists of a copolymer obtained by polymerization of:
a) one or two anionic monomers chosen from the group consisting of acrylic acid, methacrylic acid and a mixture of these monomers,
b) at least one macromonomer having a formula (I):

R_{f}-[(EO)ₘ-(PO)ₙ-(BO)ₚ]-R_{f}′ (I)
in which:
[(EO)ₘ-(PO)ₙ-(BO)ₚ] represents a polyalkoxylated chain consisting of alkoxylated units, arranged in blocks, randomly or alternatively, chosen from ethoxylated units EO, propoxylated units PO and butoxylated units BO,
m, n and p represent, independently of each other, 0 or an integer ranging between 1 and 250 (inclusive), the sum of m, n and p being between 10 and 250,
R_{f} represents a radical chosen from the group consisting of acrylic esters, methacrylic esters and a mixture of these esters,
R_{f}′ represents hydrogen or an alkyl group containing from 1 to 4 carbon atoms and
c) at least one nonionic cross-linking monomer comprising at least two radicals chosen from the group consisting of acrylic esters, methacrylic esters and a mixture of these esters.

According to one embodiment, the slump retaining agent according to the invention consists of a copolymer obtained by polymerization of:
a) from 0.5 to 40% by weight of at least one anionic monomer comprising a polymerization unsaturated function and a carboxylic group,
b) from 50 to 99% by weight of at least one macromonomer having a formula (I) and
c) from 0.05 to 10% by weight of at least one nonionic cross-linking monomer comprising at least two polymerizable saturated functions and an ester group,
   the sum of these percentages being equal to 100%.

The anionic monomers according to a) may be used in a mass proportion ranging between 0.5 and 40% by weight according to one aspect of the invention, between 5 and 30% by weight according to another aspect of the invention and between 7 and 25% by weight according to yet another aspect of the invention, the percentage being based on the total weight of all the monomers which constitute the slump agent according to the invention.

According to one embodiment, the copolymer is obtained by polymerization of from 0.5 to 40% by weight of two or more anionic monomers. For example, the copolymer is obtained by polymerization of from 0.5 to 40% by weight of two anionic monomers chosen from the group consisting of acrylic acid, methacrylic acid, maleic acid, itaconic acid and crotonic acid.

The term “poly(alkylene glycol)” means an alkylene glycol polymer derived from an olefinic oxide.

The macromonomers of formula (I) comprise a poly(alkylene glycol) chain. The poly(alkylene glycol) chains of the copolymer according to the present invention contain a proportion of ethylene-oxy groups, a proportion of propylene-oxy groups and/or a proportion of butylene-oxy groups. The poly(alkylene glycol) chains according to the present invention may, for example, comprise a dominant proportion of ethylene-oxy groups in combination with a secondary proportion of propylene-oxy groups. Specific examples of alkylene glycol polymers comprise: poly(alkylene glycols) with an average molecular weight of 1000, 4000, 6000 and 10 000 g/mol; polyethylene polypropylene glycols with a percentage of ethylene oxides between 20 and 80% by weight and a percentage of propylene oxides between 20 and 80% by weight.

The macromonomers of formula (I) may be used in a mass proportion ranging between 50 and 99% by weight according to one aspect of the invention, between 60 and 95% by weight according to another aspect of the invention and between 70 and 93% by weight according to yet another aspect of the invention, the percentage being based on the total weight of all the monomers which constitute the slump agent according to the invention. The cross-linking monomers may be used in a mass proportion ranging between 0.05 and 10% by weight according to one aspect of the invention, between 0.5 and 5% by weight according to another aspect of the invention and between 0.5 and 3% by weight according to yet another aspect of the invention, the percentage being based on the total weight of all the monomers which constitute the slump agent according to the invention. According to one embodiment of the present invention, the slump retaining agent according to the invention does not contain any ethylenically unsaturated monomer of alkyl, alkenyl or hydroxyalkyl ester type.

According to another embodiment, the slump retaining agent according to the invention does not contain any ethylenically unsaturated poly(alkylene glycol) ether monomer containing from 25 to 300 mol of C2-C3 oxyalkylene groups.

According to one embodiment of the present invention, in formula (I) above:
m represents an integer ranging between 1 and 250 (other than 0) and
n and p represent, independently of each other, 0 or an integer ranging between 1 and 250 (inclusive),
   the sum of m, n and p being between 10 and 250, for example between 20 and 200 or, for example, between 40 and 150.

According to another embodiment of the present invention, in formula (I) above:
m and n represent an integer ranging between 1 and 250 (other than 0) and
p is equal to 0,
   the sum of m and n being between 10 and 250, for example between 20 and 200 or, for example, between 40 and 150.

According to yet another embodiment, in formula (I) above:
m represents an integer ranging between 10 and 250, for example between 20 and 200 or, for example, between 40 and 150 and
n and p are equal to 0.

The slump retaining agents according to the invention have a molecular weight of greater than 400,000 g/mol. This is an essential characteristic of the invention.

The slump retaining agents according to the invention may, according to a first aspect of the present invention, have a molecular weight of between 450,000 and 800,000 g/mol (inclusive), as determined by SEC.

The slump retaining agents according to the invention may, according to a second aspect of the present invention, have a molecular weight of greater than or equal to 1,500,000 g/mol, as determined by SEC.

Specifically, the inventors have found that at these molecular weights, i.e. above 400,000 g/mol, in addition to the advantageous effect on the workability retention, the concrete or mortar formulations have a homogeneous aspect, without sedimentation of the constituents. This is an advantageous technical effect since, in the case of a sedimentation, the heavier components of fresh concrete descend by gravity, the consequence of which being segregation, packing of the concrete and the formation of a surface water film (bleeding).

In contrast, the use of agents of lower molecular weights, of the order of 100,000 to 150,000 g/mol, for example, leads to segregation of the materials in the composition, which is likely to have a negative impact on the performances of the concrete or of the hydraulic compositions that contain them.

The slump retaining agent according to the invention may be in the form of stoichiometric or non-stoichiometric, mixed or unmixed salts and may be made with alkali metals, alkaline earth metals, amines or quaternary ammoniums.

According to one embodiment, the slump retaining agent according to the invention is in acidic form.

According to another embodiment, the slump retaining agent according to the invention is in neutralized form.

According to yet another embodiment, the slump retaining agent according to the invention is in partially or totally neutralized form.

When it is in the form of salts, the slump retaining agent according to the invention may especially be a calcium salt, a sodium salt or a diethanolamine salt.

According to one embodiment, the slump retaining agent is neutralized with an ion chosen from the group consisting of the potassium ion, the sodium ion, the lithium ion, the calcium ion, the magnesium ion, the ammonium ion and a mixture of these ions.

The slump retaining agent according to the invention is in liquid form.

The additive according to the invention is water-soluble or water-dispersible.

### Workability Agent

Another object of the present invention relates to a workability agent for hydraulic compositions, which consists of a compatible mixture of the following two additives:

a slump retaining agent as defined above and

a water-reducing agent of dispersant copolymer type obtained by polymerization of:
a) at least one anionic monomer bearing a polymerizable saturated function and a carboxyl group and
b) at least one macromonomer of formula (II):

R_{d}-[(EO)ᵢ-(PO)ⱼ-(BO)ₖ]-R_{d}′ (II)
in which:
[(EO)ᵢ-(PO)ⱼ-(BO)ₖ] represents a polyalkoxylated chain consisting of alkoxylated units, arranged in blocks, randomly or alternatively, chosen from ethoxylated units EO, propoxylated units PO and butoxylated units BO,
i, j and k represent, independently of each other, 0 or an integer ranging between 1 and 150 (inclusive), the sum of i, j and k being between 1 and 250,
R_{d} represents a radical containing a polymerizable unsaturated function and
R_{d}′ represents hydrogen or an alkyl group containing from 1 to 4 carbon atoms,
   said copolymer having a molecular mass of between 20,000 g/mol and 400,000 g/mol. The constituent water-reducing agent of the workability agent according to the invention is a copolymer obtained by polymerization of anionic monomers a) and of macromonomers b). It does not comprise any cross-linking monomer.

Alternatively, the water-reducing agent is a copolymer obtained by direct esterification (or grafting or polyesterification) of a polymer (homopolymer or copolymer) containing carboxylic or anhydride functions. Reference is made, for example, to the Coatex document WO 2007/132322 which describes such a process.

Thus, according to one subject of the present invention, the workability agent for hydraulic compositions consists of a compatible mixture of the following two additives:

a slump retaining agent as defined above and

a water-reducing agent of dispersant copolymer type obtained by functionalization of a (meth)acrylic acid homopolymer and/or copolymer by esterification with at least one compound comprising a polyalkoxylated chain consisting of alkoxylated units, arranged in blocks, randomly or alternatively, chosen from ethoxylated units EO, propoxylated units PO and butoxylated units BO.

According to one embodiment, said water-reducing agent is a copolymer obtained by polymerization of macromonomers b) of formula (II) in which the radical R_{d} is chosen from the group consisting of acrylic esters, methacrylic esters, maleic esters, itaconic esters, crotonic esters and a mixture of these esters.

According to another embodiment, said water-reducing agent is a copolymer obtained by polymerization of macromonomers b) of formula (II) in which the radical R_{d} is chosen from the group consisting of acrylic esters, methacrylic esters and a mixture of these esters.

According to another embodiment, said water-reducing agent is a copolymer obtained by copolymerization of monomers a) chosen from the group consisting of acrylic acid, methacrylic acid, maleic acid, itaconic acid, crotonic acid and a mixture of these monomers.

According to one embodiment, said water-reducing agent is a copolymer obtained by copolymerization of monomers a) chosen from the group consisting of acrylic acid, methacrylic acid and a mixture of these monomers.

According to one embodiment of the present invention, in formula (II) above:
i represents an integer ranging between 1 and 250 (other than 0) and
j and k represent, independently of each other, 0 or an integer ranging between 1 and 250 (inclusive),
   the sum of i, j and k being between 1 and 250, for example between 10 and 200 or, for example, between 40 and 150.

According to another embodiment of the present invention, in formula (II) above:
i and j represent an integer ranging between 1 and 250 (other than 0) and
k is equal to 0,
   the sum of i and j being between 2 and 250, for example between 10 and 200 or, for example, between 40 and 150.

According to yet another embodiment, in formula (II) above:
i represents an integer ranging between 1 and 250, for example between 10 and 200 or, for example, between 40 and 150 and
j and k are equal to 0.

The anionic monomers may be used in a mass proportion ranging between 0.5 and 30% by weight according to one aspect of the invention, between 1 and 25% by weight according to another aspect of the invention and between 2 and 10% by weight according to yet another aspect of the invention, the percentage being based on the total weight of all the monomers which constitute the water-reducing agent.

The macromonomers of formula (II) comprise a poly(alkylene glycol) chain. The poly(alkylene glycol) chains of the copolymer according to the present invention contain a proportion of ethylene-oxy groups, a proportion of propylene-oxy groups and/or a proportion of butylene-oxy groups. The poly(alkylene glycol) chains according to the present invention may comprise, for example, a dominant proportion of ethylene-oxy groups in combination with a secondary proportion of propylene-oxy groups. Specific examples of alkylene glycol polymers comprise: poly(alkylene glycols) with an average molecular weight of 1,000, 4,000, 6,000 and 10,000 g/mol; polyethylene polypropylene glycols with a percentage of ethylene oxides of between 20 and 80% by weight and a percentage of propylene oxides of between 20 and 80% by weight.

The macromonomers of formula (II) may be used in a mass proportion ranging between 70 and 99.5% by weight according to one aspect of the invention, between 75 and 99% by weight according to another aspect of the invention and between 90 and 98% by weight according to yet another aspect of the invention, the percentage being based on the total weight of all the monomers that constitute the water-reducing agent.

The workability agent for hydraulic compositions according to the invention may consist of a compatible mixture of the slump retaining agent, as defined above, and of the water-reducing agent in proportions ranging between 1:0.1 and 1:10, for example between 1:0.2 and 1:3 or between 1:0.25 and 1:1.5 or else between 1:0.25 and 1:1.

The inventors have shown that the slump retaining agent makes it possible to lengthen the workability time of the concrete, in particular when it is added to the composition in combination with the water-reducing agent described above. It is a combination of additives with advantageous properties for hydraulic compositions, for example concretes, mortars, adhesives, fillers or grouts.

### Hydraulic Composition

In the context of the present invention, the hydraulic composition is an aqueous formulation containing water, at least one hydraulic binder, at least one slump retaining agent according to the invention and at least one water-reducing agent. The hydraulic binder comprises at least one cement, for example a Portland cement. Mention is also made, for all relevant purposes, of hydraulic binders of aluminous cement type and a sulfoalumino calcium cement.

The dosages of the slump retaining agent according to the invention and of the water-reducing agent depend mainly on the amount of hydraulic binders in the hydraulic composition. Usually, they are expressed as additive dry solids content relative to the total hydraulic binder (for example cement in the concrete and mortar compositions).

According to one embodiment of the present invention, said hydraulic composition comprises, expressed as a dry weight percentage of said slump retaining agent relative to the dry weight of cement, from 0.05% to 5% of said slump retaining agent.

According to another embodiment of the present invention, said hydraulic composition comprises, expressed as a dry weight percentage of said slump retaining agent relative to the dry weight of cement, from 0.1% to 3% of said slump retaining agent.

According to one embodiment of the present invention, said hydraulic composition comprises, expressed as a dry weight percentage of said workability agent relative to the dry weight of cement, from 0.05% to 5% of said workability agent.

According to another embodiment of the present invention, said hydraulic composition comprises, expressed as a dry weight percentage of said workability agent relative to the dry weight of cement, from 0.1% to 3% of said workability agent.

This hydraulic composition is intended, for example, for manufacturing a grout, a filler, an adhesive, a concrete or a mortar. This composition may comprise impurities, for example clays. This composition may especially comprise latices, fibers, organic granulates, inorganic granulates, fillers and/or CaCO₃.

The hydraulic compositions, for example the concrete and mortar compositions, for which the slump retaining agent according to the invention may be useful may comprise as hydraulic binder various types of cements such as cements CEM I, CEM II, CEM III, CEM V as described in standard EN 197-1. Among these, the cements CEM I do not comprise any additive. It is nevertheless possible to add to these cements slags, fly ash, calcium-based fillers or siliceous fillers. The concrete compositions may be concretes of different strength classes such as C20/25 to C100/115.

According to one embodiment, the hydraulic composition according to the invention comprises from 10 to 90% by weight of hydraulic binder.

According to one embodiment, the hydraulic composition according to the invention comprises, relative to the total weight of the composition:
from 2 to 15% by weight of water,
from 10 to 30% by weight of hydraulic binder comprising a cement,
from 0.05 to 3% by weight of said at least one slump retaining agent and
from 0.05 to 3% by weight of said at least one water-reducing agent.

According to this embodiment, the hydraulic composition according to the invention may also additionally comprise from 10 to 60% by weight of sand.

According to one embodiment, the hydraulic composition according to the invention comprises, relative to the total weight of the composition:
from 2% to 15% by weight of water,
from 10% to 30% by weight of hydraulic binder comprising a cement,
from 0.05% to 3% by weight of said at least one slump retaining agent,
from 0.05% to 3% by weight of said at least one water-reducing agent,
from 10% to 60% by weight of sand and
from 10% to 60% by weight of one or more gravels.

The hydraulic composition according to the invention may also comprise one or more of the following ingredients:
sand,
gravels,
granulates,
fine or ultrafine fillers, for example calcium carbonate or silica,
anti-foaming agent,
thickener,
stabilizer,
biocidal or antibacterial agent,
pH modifier and
setting accelerator or retardant agent.

### Uses

The present invention also relates to the use of a slump retaining agent according to the present invention, and optionally of a water-reducing agent according to the present invention, for preparing a hydraulic composition comprising water, a hydraulic binder itself comprising a cement.

The present invention also relates to the use of a workability agent according to the present invention for preparing a hydraulic composition comprising water, a hydraulic binder itself comprising a cement.

Said hydraulic composition may be, for example, a ready-mix concrete.

According to one embodiment, said slump retaining agent and said water-reducing agent are introduced separately into said hydraulic composition.

According to another embodiment, said slump retaining agent and said water-reducing agent are introduced in the form of a mixture into said hydraulic composition.

The present invention also relates to a copolymer as slump retaining agent for hydraulic compositions, said copolymer being obtained by polymerization of:
a) at least one anionic monomer comprising a polymerizable unsaturated function and a carboxylic group,
b) at least one macromonomer having a formula (I):

R_{f}-[(EO)ₘ-(PO)ₙ-(BO)ₚ]-R_{f}′ (I)
in which:
[(EO)ₘ-(PO)ₙ-(BO)ₚ] represents a polyalkoxylated chain consisting of alkoxylated units, arranged in blocks, randomly or alternatively, chosen from ethoxylated units EO, propoxylated units PO and butoxylated units BO,
m, n and p represent, independently of each other, 0 or an integer ranging between 1 and 250 (inclusive), the sum of m, n and p being between 10 and 250,
R_{f} represents a radical containing a polymerizable unsaturated function and
R_{f}′ represents hydrogen or an alkyl group containing from 1 to 4 carbon atoms and
c) at least one nonionic cross-linking monomer comprising at least two polymerizable unsaturated functions and an ester group,
   said copolymer having a molecular weight of greater than 400,000 g/mol.

Finally, the present invention relates to the use, as a workability agent for hydraulic compositions, of a combination of a slump retaining agent and a water-reducing agent, said agents being such that:

1/ the slump retaining agent is a copolymer obtained by polymerization of:
a) at least one anionic monomer comprising a polymerizable unsaturated function and a carboxylic group,
b) at least one macromonomer having a formula (I):

R_{f}-[(EO)ₘ-(PO)ₙ-(BO)ₚ]-R_{f}′ (I)
in which:
[(EO)ₘ-(PO)ₙ-(BO)ₚ] represents a polyalkoxylated chain consisting of alkoxylated units, arranged in blocks, randomly or alternatively, chosen from ethoxylated units EO, propoxylated units PO and butoxylated units BO,
m, n and p represent, independently of each other, 0 or an integer ranging between 1 and 250 (inclusive), the sum of m, n and p being between 10 and 250,
R_{f} represents a radical containing a polymerizable unsaturated function and
R_{f}′ represents hydrogen or an alkyl group containing from 1 to 4 carbon atoms and
c) at least one nonionic cross-linking monomer comprising at least two polymerizable unsaturated functions and an ester group,
   said copolymer having a molecular weight of greater than 400,000 g/mol and

2/ the water-reducing agent is a copolymer obtained by polymerization of:
a) at least one anionic monomer bearing a polymerizable saturated function and a carboxylic group and
b) at least one macromonomer of formula (II):

R_{d}-[(EO)ᵢ-(PO)ⱼ-(BO)ₖ]-R_{d}′ (II)
in which:
[(EO)ᵢ-(PO)ⱼ-(BO)ₖ] represents a polyalkoxylated chain consisting of alkoxylated units, arranged in blocks, randomly or alternatively, chosen from ethoxylated units EO, propoxylated units PO and butoxylated units BO,
i, j and k represent, independently of each other, 0 or an integer ranging between 1 and 150 (inclusive), the sum of i, j and k being between 1 and 250,
R_{d} represents a radical containing a polymerizable unsaturated function and
R_{d}′ represents hydrogen or an alkyl group containing from 1 to 4 carbon atoms,
   said copolymer having a molecular mass of between 20,000 g/mol and 400,000 g/mol. The embodiments described above concerning the slump retaining agent and the water-reducing agent are also applicable to the present part of the invention.

### EXAMPLES

The examples below illustrate the preparation of various hydraulic compositions. Measurements of initial fluidity, of workability at T45 and at T90 (slump) and of air capture are carried out on these compositions according to the following protocols.

### Measurement of the Molecular Mass of the Copolymers

In each of the following examples, the molecular mass of the copolymers according to the invention is determined by Size Exclusion Chromatography (SEC).

Such a technique uses a WATERS™ brand liquid chromatography apparatus equipped with two detectors. One of these detectors combines static dynamic light scattering at an angle of 90° with viscometry measured using a VISCOTEK™ MALVERN™ viscometry detector. The other of these detectors is a WATERS™ brand refractometric concentration detector.

This liquid chromatography apparatus is equipped with steric exclusion columns suitably chosen by the person skilled in the art so as to separate the various molecular weights of the studied polymers. The liquid elution phase is an aqueous phase containing 1% of KNO₃.

In detailed manner, according to a first step, 0.9% dry of the polymerization solution is diluted in the SEC eluent, which is a solution containing 1% of KNO₃. Then, the mixture is filtered through a 0.2 μm filter. 100 μL are then injected into the chromatography apparatus (eluent: a solution containing 1% of KNO₃).

The liquid chromatography apparatus contains an isocratic pump (WATERS™ 515) whose rate is set at 0.8 ml/min. The chromatography apparatus also comprises an oven which itself comprises in series the following system of columns: a GUARD COLUMN ULTRAHYDROGEL WATERS™ precolumn of 6 cm long and 40 mm in inside diameter, a ULTRAHYDROGEL WATERS™ linear column of 30 cm long and 7.8 mm in inside diameter and two ULTRAHYDROGEL 120 ANGSTROM WATERS™ columns of 30 cm long and 7.8 cm in inside diameter. The detection system is itself composed, firstly, of a RI WATERS™ 410 refractometric detector and, secondly, a viscometer and light scattering dual detector at an angle of 90° of the 270 DUAL DETECTOR MALVERN™ type. The oven is brought to a temperature of 55° C. and the refractometer is brought to a temperature of 45° C.

The chromatography apparatus is calibrated with a single PEO 19 k standard of PolyCAL™ MALVERN™ type.

### Measurement of the Workabilities at T0, T45 and T90—Concrete

The measurements of initial fluidity (or workability at T0) and of workability at T45 and T90 are carried out at room temperature, using a bottomless cone, of truncated conical form, made of galvanized steel, known as an Abrams cone, according to standard EN 12350-2. This cone has the following characteristics:
Upper diameter: 100±2 mm,
Lower diameter: 200±2 mm and
Height: 300±2 mm.

The cone is placed on a plate moistened with a sponge.

The cone is then filled with a given amount of each of the preparations. The filling lasts 2 minutes. The contents of the cone are packed using a metal rod.

Measurement of the Workability at T0

On termination of the filling, the cone is lifted vertically, which leads to the slump of its contents onto the plate.

The difference in height (in mm) between the height of the cone and the top of the round cake thus made is measured after 30 seconds.

Measurement of the Workability at T45 and at T90

The concrete is left to stand for 45 or 90 minutes, the formulation is worked again and the workability is then measured with the Abrams cone as indicated above.

The difference in height (in mm) between the height of the cone and the top of the round cake thus made is measured after 30 seconds.

### Measurement of the Air Capture

The air capture (%) is measured according to standard EN 12350-7, paragraph 3.3.

### Measurement of the Compressive Strength

This is measured according to standard EN 12390-3, paragraph 3. The compressive strength is measured in MPa.

### Example 1

In each of the tests 1-1 to 1-5 which follow, a concrete is prepared according to standard EN 480-1 by mixing with stirring normalized sand (0/4), cement (CEM I 52.5N Holcim), gravels 4/11 and 11/22, water and optionally an anti-foaming agent. A water-reducing agent and/or a slump retaining agent according to the invention is optionally added. The proportions of each constituent are given in table 1 below.

More precisely, the water-reducing agent illustrated in tests 1-2 and 1-5 below is a dispersing copolymer consisting of, relative to the total weight of the copolymer:
7.4% by weight of methacrylic acid monomers and
96.6% by weight of poly(ethylene-propylene) glycol methacrylate macromonomers of molecular mass 3,000 g/mol (46 ethylene oxide EO units and 15 propylene oxide PO units, arranged randomly).

The dispersing copolymer has a molecular mass ranging between 110,000 and 150,000 g/mol and is partially neutralized with NaOH (pH: 3-4.5).

The slump retaining agent illustrated in tests 1-3 to 1-5 below is a copolymer according to the invention, prepared according to the process below.

514.7 g of water are weighed out in a 1 liter reactor equipped with a mechanical stirrer and heating of oil bath type.

The following are weighed out in a first container:
19.8 g of acrylic acid,
6.7 g of methacrylic acid,
220.1 g of poly(ethylene-propylene) glycol methacrylate macromonomers of molecular mass 3,000 g/mol (46 ethylene oxide EO units and 15 propylene oxide PO units, arranged randomly) and
1.5 g of poly(ethylene glycol 200) diacrylate.

1.1 g of 1,8-dimercapto-3,6-dioxaoctane (DMDO) are weighed out in a second container (syringe).

A solution consisting of 0.9 g of ammonium persulfate and 4.4 g of deionized water is prepared in a third container.

The reagents contained in the 3 containers are placed in the reactor heated to 70° C. with stirring.

The mixture is then cooked for 2 hours at 67° C.

The whole is then partially neutralized with 50% sodium hydroxide to pH=4.5 and diluted to reach a concentration of 40.7% dry solids content.

The final polymer has the following characteristics: Mw=695,600 g/mol and Ip=5.3. The slump retaining agent illustrated consequently consists of, relative to the total weight of the copolymer:
8% by weight of acrylic acid monomers,
2.7% by weight of methacrylic acid monomers,
88.7% by weight of poly(ethylene-propylene) glycol methacrylate macromonomers of molecular mass 3,000 g/mol (46 ethylene oxide EO units and 15 propylene oxide PO units, arranged randomly) and
0.6% by weight of poly(ethylene glycol 200) diacrylate.

TABLE 1

| Tests | 1-1 | 1-2 | 1-3 | 1-4 | 1-5 |
|---|---|---|---|---|---|
| Sand (kg) | 34.4 | 34.4 | 34.4 | 34.4 | 34.4 |
| Gravel 4/11 (kg) | 15.2 | 15.2 | 15.2 | 15.2 | 15.2 |
| Gravel 11/22 (kg) | 24.2 | 24.2 | 24.2 | 24.2 | 24.2 |
| Cement (kg) | 14 | 14 | 14 | 14 | 14 |
| Total | 87.8 | 87.8 | 87.8 | 87.8 | 87.8 |
| Water-reducing agent (g) | 0 | 74 | 0 | 0 | 74 |
| % dry reducing agent/cement | — | 0.21 | — | — | 0.21 |
| Slump retaining agent (g) | 0 | 0 | 74 | 74 | 35 |
| % dry retention agent/cement | — | — | 0.21 | 0.21 | 0.10 |
| Water (g) | 9,725 | 7,600 | 7,600 | 9,221 | 7,600 |
| Water reduction | | −22% | −22% | −1.1% | −22% |
| Workability T0 (mm) | 205 | 190 | 30 | 190 | 240 |
| Workability T45 (mm) | 160 | 90 | na | na | 190 |
| Workability T90 (mm) | 60 | na | na | na | 120 |
| Air capture (%) | 1.7 | 3.3 | 2.7 | 2 | 2.1 |
| Strength 1 day (MPa) | 10 | 18 | — | — | 17 |

na: the workability measured at a preceding time is <100 ± 10 mm or the measurement is impossible

All the hydraulic compositions have a homogeneous appearance, without segregation of the constituents.

Test 1-1 is a negative control. It illustrates a hydraulic composition without admixture, i.e. without water-reducing agent and without slump retaining agent according to the invention.

In test 1-2, the use of the water-reducing agent makes it possible to reduce the amount of water by 22% in the hydraulic composition while maintaining an initial fluidity similar to that of the negative control. The water-reducing agent may be termed a high water-reducing agent in accordance with standard ADJUVANT NF EN 934-2 according to which a “high water-reducing agent” or “superplasticizer” qualifies an admixture which allows a water reduction for admixed concrete ≧12% relative to control concrete.

Tests 1-3 and 1-4 confirm the fact that the slump retaining agent illustrated is not a water-reducing agent according to standard ADJUVANT NF EN 934-2, according to which a “water-reducing agent” or “plasticizer” qualifies an admixture which allows a water reduction for admixed concrete ≧5% relative to control concrete.

Test 1-5 shows that the combination of a slump retaining agent according to the invention and of a high water-reducing agent simultaneously allows a water reduction of 22%, a good initial fluidity and also a maintenance of workability over time.

The strength at the early stages of the formulation according to test 1-5 is similar to that of the control composition (test 1-2) comprising as sole additive a water-reducing agent. It is thus demonstrated that the slump retaining agent according to the invention is not a setting retardant. It is moreover confirmed that, in accordance with standard ADJUVANT NF EN 934-2 (table 3.1), the strength values for the admixed concretes (tests 1-2 and 1-5) at 1 day are 140% higher than the strength value for the control concrete without admixture (test 1-1).

### Example 2

In each of the tests 2-1 to 2-3 which follow, a concrete is prepared according to standard EN 480-1 by mixing with stirring normalized sand (0/4), cement (CEM I 52.5N Holcim), gravels 4/11 and 11/22, water and optionally an anti-foaming agent. A combination of a water-reducing agent and of a slump retaining agent according to the invention is also added. The proportions of each constituent are given in table 2 below. More precisely, the water-reducing agent illustrated in the tests below is a dispersing copolymer identical to that of example 1.

Tests 2-1 to 2-4 illustrate various slump retaining agents according to the invention or outside the invention. They are prepared according to a procedure similar to that of example 1 above.

The slump retaining agent illustrated in test 2-1 consists of, relative to the total weight of the copolymer:
8% by weight of acrylic acid monomers,
2.7% by weight of methacrylic acid monomers,
88.7% by weight of poly(ethylene-propylene) glycol methacrylate macromonomers of molecular mass 3,000 g/mol (46 ethylene oxide EO units and 15 propylene oxide PO units, arranged randomly) and
0.6% by weight of pentaerythritol triacrylate.

Characteristics of the agent:

Mw=478,800 g/mol; Ip=3.6; partial neutralization with NaOH; pH=2.6; ES=41.7%.

The slump retaining agent illustrated in test 2-2 consists of, relative to the total weight of the copolymer:
8% by weight of acrylic acid monomers,
2.7% by weight of methacrylic acid monomers,
88.4% by weight of poly(ethylene-propylene) glycol methacrylate macromonomers of molecular mass 3,000 g/mol (46 ethylene oxide EO units and 15 propylene oxide PO units, arranged randomly) and
0.9% by weight of dipentaerythritol pentaacrylate.

Characteristics of the agent:

Mw=693,400 g/mol; Ip=4.5; partial neutralization with NaOH; pH=2.7; ES=41.9%.

The slump retaining agent illustrated in test 2-3 consists of, relative to the total weight of the copolymer:
8% by weight of acrylic acid monomers,
2.7% by weight of methacrylic acid monomers,
88.7% by weight of poly(ethylene-propylene) glycol methacrylate macromonomers of molecular mass 3,000 g/mol (46 ethylene oxide EO units and 15 propylene oxide PO units, arranged randomly) and
0.6% by weight of trimethylolpropane triacrylate.

Characteristics of the agent:

Mw=142,100 g/mol; Ip=1.8; partial neutralization with NaOH; pH=5.25; ES=40.8%.

The slump retaining agent illustrated in test 2-4 consists of, relative to the total weight of the copolymer:
8% by weight of acrylic acid monomers,
2.7% by weight of methacrylic acid monomers,
88.7% by weight of poly(ethylene-propylene) glycol methacrylate macromonomers of molecular mass 3,000 g/mol (46 ethylene oxide EO units and 15 propylene oxide PO units, arranged randomly) and
0.6% by weight of poly(ethylene glycol 200) diacrylate.

Characteristics of the agent:

Mw=100,000 g/mol; Ip=1.6; partial neutralization with NaOH; pH=5.2; ES=40.8%.

TABLE 2

| Tests | 2-1 | 2-2 | 2-3 | 2-4 |
|---|---|---|---|---|
| Sand (kg) | 34.4 | 34.4 | 34.4 | 34.4 |
| Gravel 4/11 (kg) | 15.2 | 15.2 | 15.2 | 15.2 |
| Gravel 11/22 (kg) | 24.2 | 24.2 | 24.2 | 24.2 |
| Cement (kg) | 14 | 14 | 14 | 14 |
| Total | 87.8 | 87.8 | 87.8 | 87.8 |
| Water-reducing agent (g) | 74 | 74 | 74 | 74 |
| % dry reducing agent/cement | 0.21 | 0.21 | 0.21 | 0.21 |
| Slump retaining agent (g) | 33 | 33 | 34 | 34 |
| % dry retention agent/cement | 0.1 | 0.1 | 0.1 | 0.1 |
| Initial fluidity (mm) | 230 | 230 | 240 | 260 |
| Workability T45 (mm) | 175 | 220 | 220 | 250 |
| Workability T90 (mm) | 50 | 110 | 220 | 50 |
| Air capture (%) | 2.7 | 2.7 | 2.7 | 2.7 |
| Appearance of the hydraulic | Homogeneous | Homogeneous | Slight | Strong |
| composition | | | segregation | segregation |

na: the workability measured at a preceding time is <100 ± 10 mm or the measurement is impossible

All the copolymers illustrated in the table allow a maintenance of the workability over time.

The slump retaining agents according to the invention (tests 2-1 and 2-2), of molecular weight greater than 400,000 g/mol, do not cause any segregation of the constituents in the hydraulic composition. On the other hand, the copolymers of tests 2-3 and 2-4 cause segregation of the constituents in the hydraulic composition and therefore do not constitute good additives for hydraulic compositions. Tests 2-1 to 2-2 moreover show that the combination of said slump retaining agents according to the invention and of a high water-reducing agent simultaneously allows good initial fluidity and also maintenance of workability over time.

### Example 3

In tests 3-1, 3-2 and 3-3, 3-4 which follow, a concrete is prepared according to standard EN 480-1 by mixing with stirring normalized sand (0/4), cement (CEM I 52.5N Holcim), gravels 4/11 and 11/22, water and a water-reducing agent and also a slump retaining agent according to the invention are added at two different doses. The proportions of each constituent are given in table 3 below.

Tests 3-1 and 3-2 illustrate a slump retaining agent according to the invention. They are prepared according to a procedure similar to that of example 1 above.

This agent consists of, relative to the total weight of the copolymer:
8% by weight of acrylic acid monomers,
2.7% by weight of methacrylic acid monomers,
88.7% by weight of poly(ethylene-propylene) glycol methacrylate macromonomers of molecular mass 3,000 g/mol (46 ethylene oxide EO units and 15 propylene oxide PO units, arranged randomly) and
0.6% by weight of poly(ethylene glycol 200) diacrylate.

Characteristics of the agent:

Mw=7,860,000 g/mol; Ip=5.3; partial neutralization with NaOH; pH=5.7; ES=26.1%.

Tests 3-3 and 3-4 illustrate a slump retaining agent according to the invention. They are prepared according to a procedure similar to that of example 1 above.

This agent consists of, relative to the total weight of the copolymer:
8.1% by weight of acrylic acid monomers,
2.7% by weight of methacrylic acid monomers,
88.6% by weight of poly(ethylene-propylene) glycol methacrylate macromonomers of molecular mass 3,000 g/mol (46 ethylene oxide EO units and 15 propylene oxide PO units, arranged randomly) and
0.6% by weight of trimethylolpropane triacrylate.

Characteristics of the agent:

Mw=616,700 g/mol; Ip=2.4; partial neutralization with NaOH; pH=5.8; ES=26.2%.

TABLE 3

| Tests | 3-1 | 3-2 | 3-3 | 3-4 |
|---|---|---|---|---|
| Sand (kg) | 34.4 | 34.4 | 34.4 | 34.4 |
| Gravel 4/11 (kg) | 15.2 | 15.2 | 15.2 | 15.2 |
| Gravel 11/22 (kg) | 24.2 | 24.2 | 24.2 | 24.2 |
| Cement (kg) | 14 | 14 | 14 | 14 |
| Total | 87.8 | 87.8 | 87.8 | 87.8 |
| Water-reducing agent (g) | 74 | 74 | 74 | 74 |
| % dry reducing agent/cement | 0.21 | 0.21 | 0.21 | 0.21 |
| Slump retaining agent (g) | 75 | 54 | 101 | 53 |
| % dry retention agent/cement | 0.14 | 0.10 | 0.19 | 1.10 |
| Initial fluidity (mm) | 230 | 215 | 240 | 210 |
| Workability T60 (mm) | 230 | 130 | 230 | 190 |
| Workability T90 (mm) | / | 120 | / | / |
| Workability T120 (mm) | 171 | 80 | 140 | 120 |
| Air capture (%) | 2.8 | 2.8 | 2.5 | 2.7 |

1. A slump retaining agent for a hydraulic composition, which consists of a copolymer obtained by polymerization of:
a) at least one anionic monomer comprising a polymerizable unsaturated function and a carboxylic group,
b) at least one macromonomer having a formula (I):
R_{f}-[(EO)ₘ-(PO)ₙ-(BO)ₚ]-R_{f}′ (I)
in which:
[(EO)ₘ-(PO)ₙ-(BO)ₚ] represents at least one polyalkoxylated chain consisting of alkoxylated units, arranged in blocks, randomly or alternatively, selected from the group consisting of ethoxylated units EO, propoxylated units PO and butoxylated units BO,
m, n and p represent, independently of each other, 0 or an integer ranging from 1 to 250 (inclusive), the sum of m, n and p being between 10 and 250,
R_{f} represents a radical containing a polymerizable unsaturated function and
R_{f}′ represents hydrogen or an alkyl group containing from 1 to 4 carbon atoms and
c) at least one nonionic cross-linking monomer comprising at least two polymerizable unsaturated functions and an ester group,
wherein said copolymer has a molecular weight of greater than 400,000 g/mol as determined by SEC; and
wherein said slump retaining agent is not a water reducing agent according to standard ADVJUVANT NF EN 934.2.

2. The slump retaining agent according to claim 1, according to which the monomers a) are at least one selected from the group consisting of acrylic acid, methacrylic acid, maleic acid, itaconic acid, crotonic acid and a mixture of these monomers.

3. The slump retaining agent according to claim 1, according to which the polymerizable unsaturated functions of monomers b) and c), independently of each other, are at least one selected from the group consisting of acrylic esters, methacrylic esters, maleic esters, itaconic esters and crotonic esters.

4. The slump retaining agent according to claim 1, consisting of a copolymer obtained by polymerization of:
a) from 0.5 to 40% by weight of at least one anionic monomer comprising a polymerization unsaturated function and a carboxylic group,
b) from 50 to 99% by weight of at least one macromonomer having a formula (I) and
c) from 0.05 to 10% by weight of at least one nonionic cross-linking monomer comprising at least two polymerizable saturated functions and an ester group,
the sum of the percentages being equal to 100%.

5. A workability agent for a hydraulic composition, consisting of a compatible mixture of the following two additives:
a slump retaining agent according to claim 1 and
a water-reducing agent of dispersing copolymer type obtained by polymerization of:
a) at least one anionic monomer bearing a polymerizable saturated function and a carboxyl group and
b) at least one macromonomer of formula (II):
R_{d}-[(EO)ᵢ-(PO)ⱼ-(BO)ₖ]-R_{d}′ (II)
in which:
[(EO)ᵢ-(PO)ⱼ-(BO)ₖ] represents at least one polyalkoxylated chain consisting of alkoxylated units, arranged in blocks, randomly or alternatively, selected from the group consisting of ethoxylated units EO, propoxylated units PO and butoxylated units BO,
i, j and k represent, independently of each other, 0 or an integer ranging between 1 and 150 (inclusive), the sum of i, j and k being between 1 and 250,
R_{d} represents a radical containing a polymerizable unsaturated function and
R_{d}′ represents hydrogen or an alkyl group containing from 1 to 4 carbon atoms,
said copolymer having a molecular mass of between 20,000 g/mol and 400,000 g/mol.

6. A hydraulic composition comprising:
water,
a hydraulic binder comprising a cement,
a slump retaining agent according to claim 1 and
a water-reducing agent of dispersing copolymer type obtained by polymerization of:
a) at least one anionic monomer bearing a polymerizable unsaturated function and a carboxyl group and
b) at least one macromonomer of formula (II):
R_{d}-[(EO)ᵢ-(PO)ⱼ-(BO)ₖ]-R_{d}′ (II)
in which:
[(EO)ᵢ-(PO)ⱼ-(BO)ₖ] represents a polyalkoxylated chain consisting of alkoxylated units, arranged in blocks, randomly or alternatively, at least one selected from ethoxylated units EO, propoxylated units PO and butoxylated units BO,
i, j and k represent, independently of each other, 0 or an integer ranging between 1 and 150 (inclusive), the sum of i, j and k being between 1 and 250,
R_{d} represents a polymerizable unsaturated function and
R_{d}′ represents hydrogen or an alkyl group containing from 1 to 4 carbon atoms,
said copolymer having a molecular mass of between 20,000 g/mol and 400,000 g/mol.

7. A method for preparing a hydraulic composition comprising admixing a slump retaining agent according to claim 1 water, and a hydraulic binder comprising a cement.

8. The method according to claim 7, further comprising admixing a water-reducing agent of copolymer type obtained by polymerization of:
a) at least one anionic monomer bearing a polymerizable unsaturated function and a carboxyl group and
b) at least one macromonomer of formula (II):
R_{d}-[(EO)ᵢ-(PO)ⱼ-(BO)ₖ]-R_{d}′ (II)
in which:
[(EO)ᵢ-(PO)ⱼ-(BO)ₖ] represents at least one polyalkoxylated chain consisting of alkoxylated units, arranged in blocks, randomly or alternatively, selected from ethoxylated units EO, propoxylated units PO and butoxylated units BO,
i, j and k represent, independently of each other, 0 or an integer ranging between 1 and 150 (inclusive), the sum of i, j and k being between 1 and 250,
R_{d} represents a polymerizable unsaturated function and
R_{d}′ represents hydrogen or an alkyl group containing from 1 to 4 carbon atoms,
said copolymer having a molecular mass of between 20,000 g/mol and 400,000 g/mol.

9. The method according to claim 8, according to which said slump retaining agent and said water-reducing agent are introduced separately into said hydraulic composition.

10. The method according to claim 8, according to which said slump retaining agent and said water-reducing agent are introduced in the form of a mixture into said hydraulic composition.

11. The method according to claim 7, in which said hydraulic composition is a ready-mix concrete.
